(19) United States
(12) Patent Application Publication
(10) Pub. No.: US 2008/0167975 A1
(43) Pub. Date: Jul. 10, 2008

(54) CYBER SHOPPING MALL MANAGEMENT APPARATUS, AND SYSTEM AND METHOD FOR MANAGING CYBER SHOPPING MALL USING THE SAME

(75) Inventors: Jae Sun Park, Suwon-si (KR); Young Bae Lee, Seoul (KR); Sang Kil Ahn, Seoul (KR); Jae Wook Kim, Hwaseong-si (KR); Yong Sung Chun, Seoul (KR); Ki Sung Kwon, Metropolitan City (KR); Yun Sang Park, Suwon-si (KR); Young Min Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/966,310

(22) Filed: Dec. 28, 2007

(30) Foreign Application Priority Data
Dec. 28, 2006 (KR) 2006-0136207

(51) Int. Cl. G06Q 30/00; G09G 5/00

(52) U.S. Cl. 705/27; 345/666

(57) ABSTRACT

Provided are a cyber shopping mall management apparatus, and a system and method for managing a cyber shopping mall using the apparatus that can reduce a return rate of a purchased wear item. The cyber shopping mall management method includes adjusting a size of an image of a wear item to be purchased to fit a size of an image of an object to wear the wear item, synthesizing the adjusted wear item image onto the object image, and transmitting the synthesized image to a buyer. Thus, the cyber shopping mall management system and method enable a buyer to indirectly examine whether a wear item to be purchased can fit an object through an image of the object wearing the desired wear item, thus reducing a return rate of purchased wear items.

### PRIORITY

This application claims priority under 35 U.S.C. §119 to an application entitled “CYBER SHOPPING MALL MANAGEMENT APPARATUS, AND SYSTEM AND METHOD FOR MANAGING CYBER SHOPPING MALL USING THE SAME” filed in the Korean Intellectual Property Office on Dec. 28, 2006 and assigned Serial No. 2006-0136207, the contents of which are incorporated herein by reference.

### BACKGROUND OF THE INVENTION

1. Field of the Invention

The present invention relates to a shopping mall, and, more particularly, to a cyber shopping mall management apparatus for displaying items for sale and a system and method for managing a cyber shopping mall using the cyber shopping mall management apparatus.

2. Description of the Related Art

Recent development in Electronic Commerce (e-commerce) has induced consumers to switch from conventional shopping off-line to on-line shopping. Thus, the growth rate of on-line shopping via on-line stores (hereinafter ‘cyber shopping mall’) is increasing. Examples of on-line shopping via such a cyber shopping mall may include home shopping and Internet shopping. Most cyber shopping malls provide information about products for sale. Information about a particular product contains images, characteristics, price, manufacturer, retailer, and delivery method for the product.

A buyer determines whether to purchase a product based on product information and makes a purchase via a wired/wireless communication terminal (hereinafter ‘buyer terminal’). Examples of a buyer terminal may be a wired phone, mobile communication terminal, Personal Digital Assistant (PDA), Portable Multimedia Player (PMP), notebook, and Personal Computer (PC).

When a buyer purchases a product on-line, in particular a product is apparel, such as clothing, eyeglasses or other accessories, most cyber shopping malls do not enable the buyer to view the desired product with the naked eye and directly try wearing the product before purchasing. Thus, the buyer frequently returns a purchased product when the product does not fit or look satisfactory, which can lead to a high return rate. That is, a high return rate is due to a difference in impression between an actual size and appearance of a product and a size and appearance of a corresponding product image displayed on a screen. Further, the buyer cannot precisely recognize the size of the apparel (also referred to as a wear product) using only product information.

For example, if a buyer purchases a garment in a cyber shopping mall, they make a purchase decision based on information about the garment such as garment images and dimensions provided by a retailer. That is, the cyber shopping mall does not enable the buyer to try wearing the garment to ensure that it fits their body before the purchased garment arrives. Thus, if the garment does not fit or look satisfactory, the buyer frequently returns the item.

### SUMMARY OF THE INVENTION

In order to solve the above problems, the present invention provides a cyber shopping mall management apparatus, and a system and method for managing a cyber shopping mall using the same that enable a buyer to virtually wear a wear item to ensure that it fits before purchasing.

The present invention further provides a cyber shopping mall management apparatus, and a system and method for managing a cyber shopping mall using the same that reduce a return rate of wear items purchased through the cyber shopping mall.

In accordance with an exemplary embodiment of the present invention, a cyber shopping mall management method is provided, including transmitting information about at least one wear item through a communication network and displaying the at least one wear item on a screen; receiving a selection signal from a buyer terminal for selecting a wear item among the displayed at least one wear item; receiving from the buyer terminal an image of an object to wear the selected wear item and an actual size of a specific portion of the object; computing an image size of the specific portion of the object; computing an object image ratio between the computed image size and the actual size; adjusting an image of the selected wear item according to the computed object image ratio; synthesizing the adjusted image of the selected wear item onto a portion of the object image wearing the wear item; and transmitting the synthesized image obtained by synthesizing to the buyer terminal.

Preferably, the information about the at least one wear item is displayed on at least one of a display of the buyer terminal, a television, and a personal computer monitor. The received object image includes a portion on which the selected wear item will be worn.

Preferably, computing an image size of the specific portion includes extracting the specific portion from the received object image and computing the image size of the extracted specific portion. The computed image size and the corresponding actual size are one of a length and an area of the specific portion.

Preferably, in adjusting an image of the selected wear item, a ratio between the image size of the selected wear item and the actual size of the selected wear item is adjusted to be equal to the computed object image ratio. Alternatively, the computed object image ratio of the received object image may be adjusted to be equal to a ratio between the image size of the selected wear item and the actual size of the selected wear item.

Preferably, the cyber shopping mall management method further includes receiving information necessary to purchase the selected wear item from the buyer terminal.

In accordance with another exemplary embodiment of the present invention,

a cyber shopping mall management apparatus is provided, including a transmitter, a receiver, a calculator, an adjuster, and a synthesizer.

The transmitter transmits information about at least one wear item so that the at least one wear item can be displayed on a screen. The receiver receives from a buyer terminal a selection signal for selecting a wear item, an image of an object to wear the selected wear item, and an actual size of a specific portion of the object. The calculator computes an image size of the specific portion of the object and computes an object image ratio between the computed image size and the actual size. The adjuster adjusts an image of the selected wear item according to the computed object image ratio. The synthesizer synthesizes the adjusted image of the selected wear item onto a portion of the object image to wear the wear item, wherein the transmitter transmits the image synthesized by the synthesizer to the buyer terminal.

In accordance with another exemplary embodiment of the present invention, a cyber shopping mall management system is provided, including a cyber shopping mall management apparatus for providing information about at least one wear item for sale; a display unit for receiving the information about the at least one wear item through a communication network and displaying the at least one wear item; and a buyer terminal for transmitting to the cyber shopping mall management apparatus a selection signal for selecting a wear item among the displayed at least one wear item, an image of an object to wear the selected wear item, and an actual size of a specific portion of the object.

### BRIEF DESCRIPTION OF THE DRAWINGS

The objects, features, and advantages of the present invention will be more apparent from the following detailed description in conjunction with the accompanying drawings, in which:

FIG. 1 is a block diagram of a cyber shopping mall management system according to an exemplary embodiment of the present invention;

FIG. 2 is a block diagram of a configuration of a cyber shopping mall management apparatus according to an exemplary embodiment of the present invention;

FIG. 3 is a flowchart illustrating a cyber shopping mall management method according to an exemplary embodiment of the present invention; and

FIG. 4 is a diagram showing examples of screens illustrating the cyber shopping mall management method of FIG. 3.

### DETAILED DESCRIPTION OF THE PREFERRED EMBODIMENTS

Hereinafter, preferred embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention. In the exemplary embodiments described, the term wear items refers to goods such as apparel that is worn on or covers humans, animals, or objects, including garments, spectacles, and interior items.

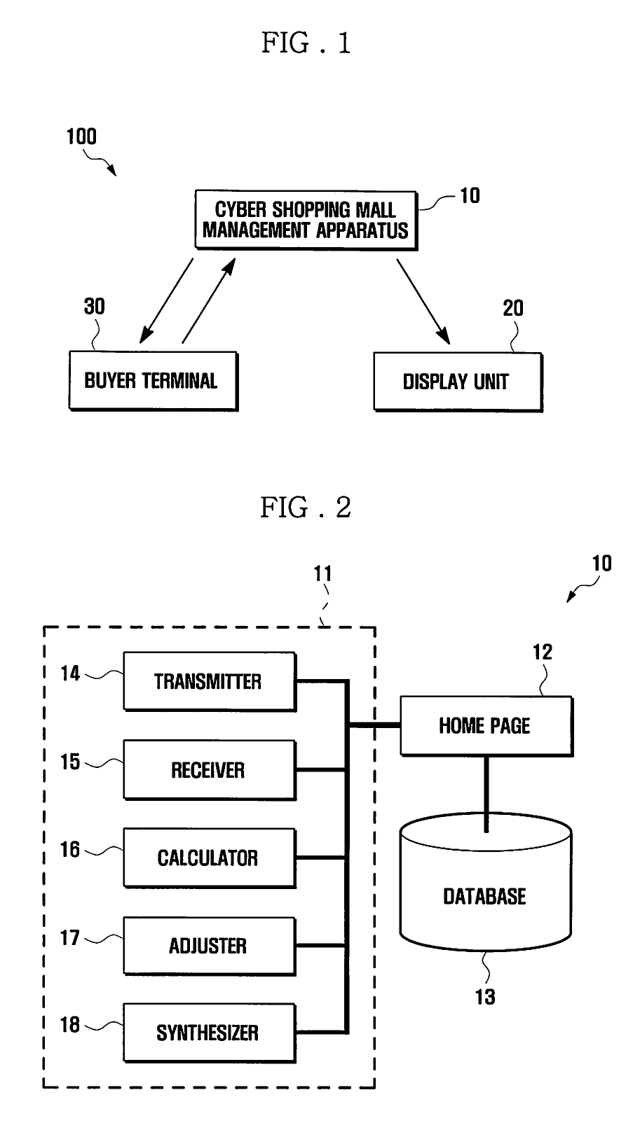

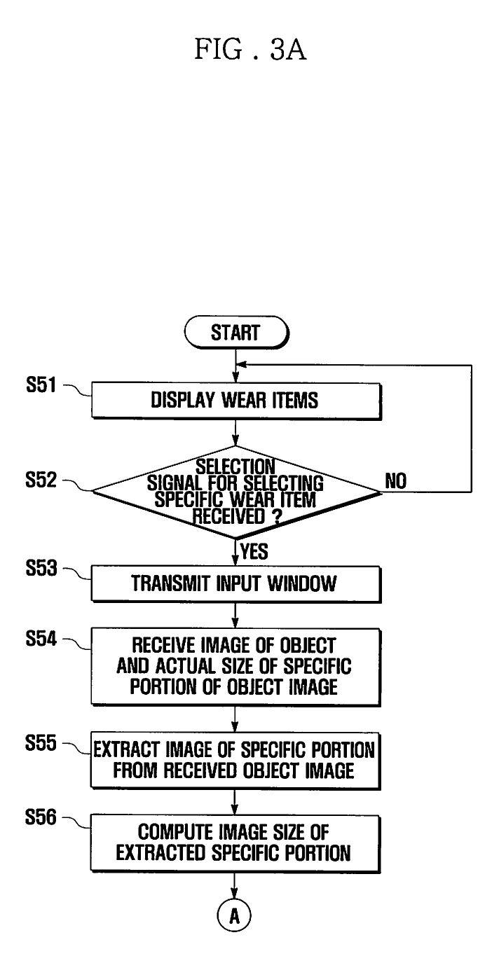

FIG. 1 is a block diagram of a cyber shopping mall management system 100 according to an exemplary embodiment of the present invention, and FIG. 2 is a block diagram of a configuration of a cyber shopping mall management apparatus 10 of the present invention, illustrated in use in FIG. 1.

Referring to FIGS. 1 and 2, the cyber shopping mall system 100 includes the cyber shopping mall management apparatus 10, a display unit 20, and a buyer terminal 30. The cyber shopping mall management apparatus 10 provides information about wear items that are for sale. The display unit 20 receives the information about wear items from the cyber shopping mall management apparatus 10 via a communication network and displays the wear items. The buyer terminal 30 transmits to the cyber shopping mall management apparatus 10 a signal for selecting a wear item from among the wear items displayed on the display unit 20, an image of an object to wear the selected wear item, and an actual size of a specific portion of the object.

In this case, a buyer obtains information about a wear item to be purchased through the display unit 20 and additional information necessary to purchase the wear item from the buyer terminal 30. The additional information includes an image of an object wearing the wear item, as described below.

Thus, according to the present exemplary embodiment, the buyer indirectly checks whether a wear item will fit an object through an image of the object wearing the wear item. Because the buyer purchases the wear item based on the image of the object wearing it, it is possible to reduce a return rate of the purchased wear item.

The cyber shopping mall management system 100 according to the present exemplary embodiment is described in detail with reference to FIGS. 1 and 2 as follows.

The display unit 20 is typically a television (TV) or Personal Computer (PC) monitor. Alternatively, the display unit 20 is a display unit of the buyer terminal 30.

The buyer terminal 30 is a terminal having a display unit that is connected to the cyber shopping mall management apparatus 10 via a communication network. In this case, examples of the buyer terminal 30 may be a wired phone, mobile communication terminal, Personal Digital Assistant (PDA), notebook, and PC.

Examples of the communication network may be a telephone line, coaxial cable, fiber optic communication network, wireless communication network, Packet Switching Network (PSN), Integrated Services Digital Network (ISDN), and Broadband-ISDN (B-ISDN). Examples of the wireless communication network may be Code Division Multiple Access (CDMA), Global System for Mobile Communication (GSM), Wideband CDMA (WCDMA), High-Speed Downlink Packet Access (HSDPA), and Wireless Broadband (WiBro) networks.

The cyber shopping mall management apparatus 10 includes a server 11 capable of providing services via the Internet. The cyber shopping mall management apparatus 10 further includes a home page 12, to which the buyer terminal 30 and the display unit 20 can connect. The server 11 operates and manages the home page 12 to provide services to users, including a buyer who has accessed the home page 12. The cyber shopping mall management apparatus 10 further includes a database 13 containing information about wear items. The information about each wear item may include images, price, identification (ID) code, characteristics, manufacturer, retailer, delivery method, and an image ratio. The image ratio refers to the ratio between an image size and an actual size of the wear item.

The server 11 provides a web page or Wireless Application Provider (WAP) page as the home page 12. If the buyer terminal 30 is connected to the cyber shopping mall management apparatus 10 via a mobile communication network, a WAP page can be provided to the buyer terminal 30.

The server 11 includes a transmitter 14, a receiver 15, a calculator 16, an adjuster 17, and a synthesizer 18.

The transmitter 14 sends information about wear items to the display unit 20 so that the information can be displayed on the screen of the display unit 20. That is, the transmitter 14 extracts information from the database 13 about wear items requested by the buyer and sends the information to the display unit 20.

The receiver 15 receives a signal from the buyer terminal 30 for selecting a specific item from among displayed wear items, an image of an object to wear the selected wear item, and information about an actual size of a specific portion of the object. That is, the receiver 15 receives information necessary to purchase the wear item selected by the buyer.

The calculator 16 calculates the size of a specific portion of the received object image and the ratio between the size obtained by the calculator 16 and the actual size of the specific portion. More specifically, the calculator 16 extracts the specific portion from the received object image and calculates the size of the specific portion. To obtain a ratio between the actual size and the calculated size obtained by the calculator 16, the calculator 16 divides the actual size by the calculated size or the calculated size by the actual size. The calculated size and actual size include one of a length and an area of the specific portion.

Although, in the above description, the received image is an object image, typically the receiver 15 receives an image including an object image and other images such as a background image or other object images. Thus, the calculator 16 may extract an object image from the received image before extracting a specific portion of the object image.

The adjuster 17 adjusts an image ratio of the selected wear item corresponding to the ratio obtained by the calculator 16. In this case, the adjuster 17 adjusts the image ratio of the selected wear item image to be equal to the obtained ratio of the received object image or the obtained ratio of the received object image to be equal to the image ratio of the selected wear item image.

The synthesizer 18 synthesizes the selected wear item image onto the object image. That is, the synthesizer 18 merges the selected wear item image onto a portion of the object image wearing the wear item.

The transmitter 14 transmits the synthesized image to the buyer terminal 30, thus enabling the buyer to check the synthesized image through a display of the buyer terminal 30 and to examine whether the selected wear item fits the object.

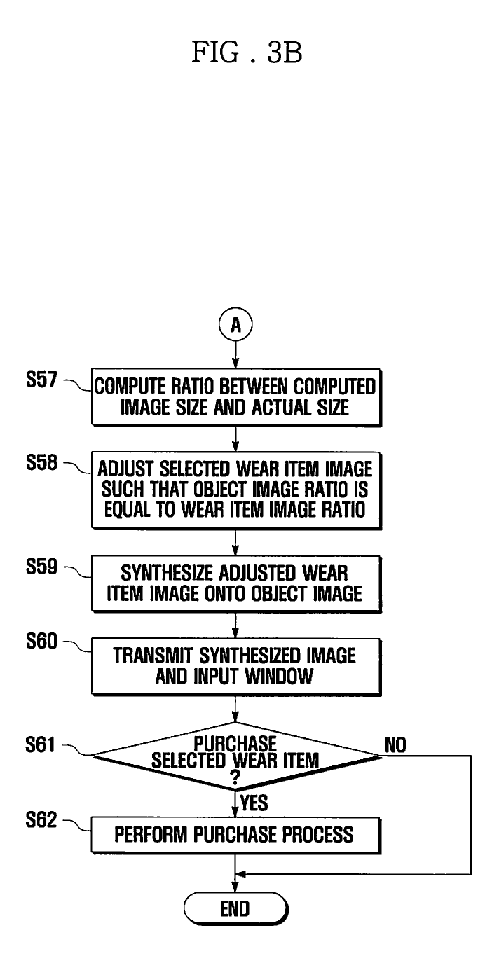

FIG. 3 is a flowchart illustrating a cyber shopping mall management method according to an exemplary embodiment of the present invention. The cyber shopping mall management method according to the present embodiment is described in detail with reference to FIGS. 1 through 3 as follows.

Referring to FIGS. 1 through 3, first, the transmitter 14 of the cyber shopping mall management apparatus 10 sends information about wear items so that the display unit 20 displays the wear items in Step 51. More specifically, the transmitter 14 extracts information about wear items requested by a buyer from the database 13 and sends the information to the display unit 20 so that the display unit 20 can display the wear items.

The receiver 15 then determines whether a selection signal for selecting an item among the displayed wear items is received from the buyer terminal 30 in Step 52. For example, the selection signal may be generated when the buyer accesses the home page 12 of the cyber shopping mall management apparatus 10 via the buyer terminal 30 to enter an ID code of a specific wear item or select virtual wearing of the specific wear item.

If a selection signal is received at Step 52, the transmitter 14 transmits an input window that enables the buyer to enter a location of an image of an object and an actual size of a specific portion of the object in Step 53.

The receiver 15 receives the location of the object image and the actual size of the specific portion of the object input into the input window from the buyer terminal 30 in Step 54. In this case, the input window contains an address at which the object image is located. The address may be an address in a storage unit or memory of the buyer terminal 30 in which the object image is stored or a Universal Resource Locator (URL) address.

The calculator 16 extracts the specific portion of the received object image in Step 55 and computes the size of the extracted specific portion in step S56. The calculator 16 then calculates a ratio between the computed size of the specific portion and the actual size in Step 57.

The adjuster 17 then adjusts at least one of an image ratio of the selected wear item image and the ratio obtained by the calculator 16 such that the image ratio is equal to the obtained ratio in Step 58. That is, the adjuster 17 adjusts the image ratio of the selected wear item image to be equal to the obtained ratio or adjusts the obtained ratio to be equal to the image ratio.

The synthesizer 18 synthesizes the selected wear item image subjected to the adjustment into the resulting object image in Step 59. That is, the synthesizer 18 merges the selected wear item image onto the portion of the object image at which the wear item is worn.

Thereafter, the transmitter 14 transmits the synthesized image to the buyer terminal 30 in Step 60. The buyer then checks the synthesized image through the display of the buyer terminal 30 to examine whether the selected wear item fits the object. In this case, the transmitter 14 may transmit the synthesized image, together with a purchase window asking the buyer whether to purchase the selected wear item. For example, the purchase window may contain one or more buttons such as “Yes” and “No” so that the buyer can select “Yes” or “No” through the buyer terminal 30.

The receiver 15 then determines whether the selected wear item is purchased according to the result of selection on the purchase window in Step 61. The buyer may then check the synthesized image to ensure that the selected wear item fits the object and appears satisfactory. If the buyer selects the “Yes” button on the purchase window, upon selection of the “Yes” button, the receiver 14 determines that the buyer has decided to purchase the selected wear item. The server 11 performs a process necessary for purchasing the selected wear item with the buyer terminal 30 in Step 62.

If the buyer selects the “No” button on the purchase window (for example in a case where the buyer finds that the selected wear item does not fit the object satisfactorily), the receiver 14 determines that the buyer has selected not to purchase the wear item.

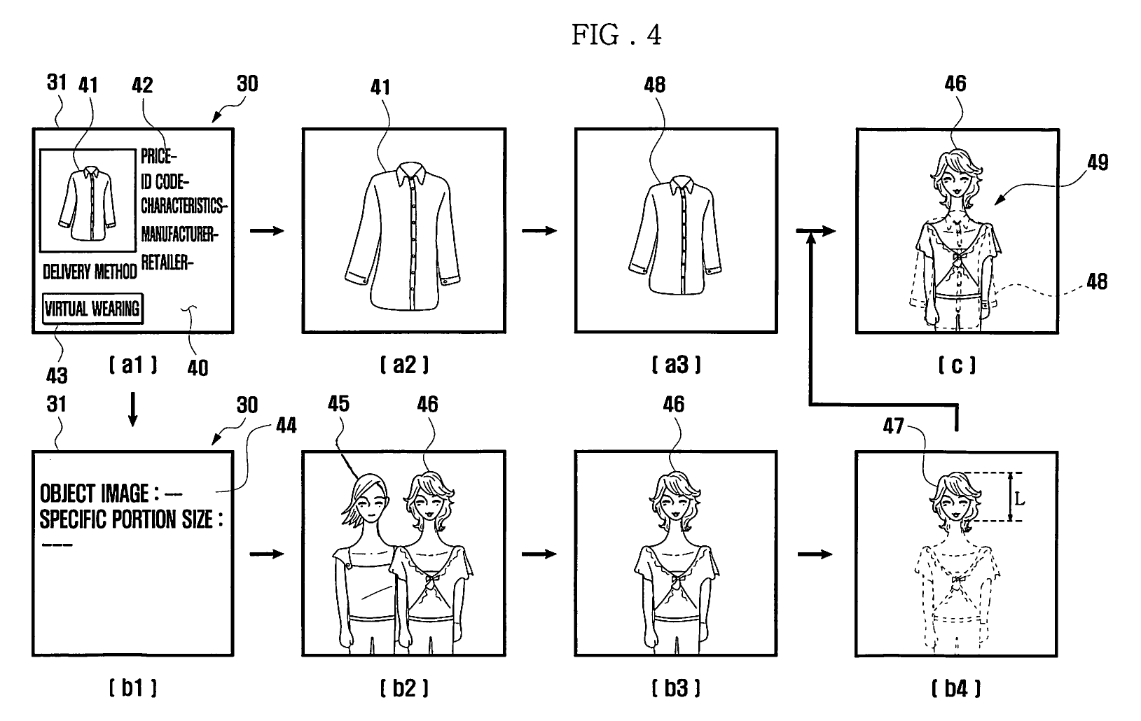

FIG. 4 is a diagram showing examples of screens illustrating the cyber shopping mall management method of FIG. 3. The cyber shopping mall management method according to the present exemplary embodiment is described in more detail with reference to FIGS. 1 through 4. It is assumed in FIG. 4 that a selected wear item is a shirt.

Referring to display a1 of FIG. 4, the buyer accesses the home page 12 managed by the server 11 via the buyer terminal 30 to move to a page 40 on which a desired shirt is displayed. The page 40 includes an image 41 of the shirt and information 42 associated with the shirt.

If the buyer selects virtual wearing 43 on the page 40 displayed on the buyer terminal 30, an input window 44 is displayed on a display 31 of the buyer terminal 30, as illustrated in display b1 of FIG. 4. The buyer then enters an address at which an image of an object is located and an actual size of a specific portion of the object into the input window 44 and sends the same to the receiver 15.

In this case, as illustrated in display b2 of FIG. 4, the buyer sends an image 45 including an object image 46. The object image 46 refers to an image of a person i.e. the purchaser, who will wear the shirt. Preferably, the object image 46 represents a portion of the person's body from the head to a point slightly below the waist, as will be covered by the shirt. The specific portion of the object may be, for example, the person's head and the actual size may be, for example, a length of the head.

Referring to display b3 in FIG. 4, the calculator 16 extracts the object image 46 from the received image 45. Referring to display b4 in FIG. 4, the calculator 16 extracts an image 47 of a specific portion of the object and computes the size of the extracted specific portion (that is, length L). The calculator 16 also calculates a ratio between the computed size and the actual size. Thereafter, as illustrated in displays a2-a3 of FIG. 4, the adjuster 17 adjusts an image ratio of the selected shirt to fit the ratio obtained by the calculator 16. Display a2 in FIG. 4 shows the image 41 of the selected shirt, and display a3 in FIG. 4 shows a shirt image 48 subjected to the adjustment.

Referring to display c in FIG. 4, the synthesizer 18 merges the shirt image 48 onto the portion of the object image 46 covered with the shirt. Thereafter, the transmitter 14 sends a synthesized image 49 to the buyer terminal 30.

As described above, the cyber shopping mall management method according to the present exemplary embodiments includes adjusting an image size of a wear item to be purchased to fit an image size of an object to wear the wear item, synthesizing a wear item image subjected to the adjustment onto the resulting object image, and transmitting the resulting image to a buyer. Thus, a cyber shopping mall management system and method according to the present invention enables a buyer to indirectly examine whether a wear item to be purchased can fit an object through an image of the object wearing the desired wear item, thus reducing a return rate of purchased wear items.

While the present invention has been particularly shown and described with reference to exemplary embodiments thereof, the description of the exemplary embodiments is to be construed as exemplary only and does not describe every possible instance of the invention. Therefore, it should be understood that various changes may be made without departing from the spirit and scope of the present invention as defined by the following claims.

What is claimed is:

1. A cyber shopping mall management method comprising:
transmitting information about at least one wear item through a communication network and displaying the at least one wear item on a screen;
receiving a selection signal from a buyer terminal for selecting a wear item from among the displayed at least one wear item;
receiving from the buyer terminal an image of an object to wear the selected wear item and an actual size of a specific portion of the object;
computing an image size of the specific portion of the object;
computing an object image ratio between the computed image size and the actual size;
adjusting an image of the selected wear item according to the computed object image ratio;
synthesizing the adjusted image of the selected wear item onto a portion of the object image to display wearing of the wear item; and
transmitting the synthesized image to the buyer terminal.

2. The method of claim 1, wherein the information about the at least one wear item is displayed on at least one of a display of the buyer terminal, a television and a personal computer monitor.

3. The method of claim 1, wherein the received object image includes a portion of the object on which the selected wear item will be worn.

4. The method of claim 3, wherein computing an image size of the specific portion of the object comprises:
extracting the specific portion from the received object image; and
computing the image size of the extracted specific portion.

5. The method of claim 4, wherein the computed image size and the corresponding actual size are one of a length and an area of the specific portion.

6. The method of claim 5, wherein in adjusting an image of the selected wear item, a ratio between the image size of the selected wear item and an actual size of the selected wear item is adjusted to be equal to the computed object image ratio.

7. The method of claim 5, wherein in adjusting an image of the selected wear item, the computed object image ratio of the received object image is adjusted to be equal to a ratio between the image size of the selected wear item and an actual size of the selected wear item.

8. The method of claim 1, further comprising receiving information necessary to purchase the selected wear item from the buyer terminal.

9. A cyber shopping mall management apparatus comprising:
a transmitter for transmitting information about at least one wear item so that the at least one wear item can be displayed on a screen;
a receiver for receiving from a buyer terminal a selection signal for selecting a wear item, an image of an object to wear the selected wear item, and an actual size of a specific portion of the object;
a calculator for computing an image size of the specific portion of the object and for computing an object image ratio between the computed image size and the actual size;
an adjuster for adjusting an image of the selected wear item according to the computed object image ratio; and
a synthesizer for synthesizing the adjusted image of the selected wear item onto a portion of the object image to display wearing of the wear item,
wherein the transmitter transmits the image obtained by synthesizing to the buyer terminal.

10. The apparatus of claim 9, wherein the calculator extracts the specific portion from the received object image and computes the image size of the specific portion.

11. The apparatus of claim 10, wherein the computed image size and the corresponding actual size are one of a length and an area of the specific portion.

12. The apparatus of claim 11, wherein the adjuster adjusts a ratio between the image size of the selected wear item and an actual size of the selected wear item to be equal to the computed object image ratio.

13. The apparatus of claim 11, wherein the adjuster adjusts the computed object image ratio of the received object image to be equal to a ratio between the image size of the selected wear item and the actual size of the selected wear item.

14. The apparatus of claim 9, wherein the receiver receives information necessary to purchase the selected wear item from the buyer terminal.

15. A cyber shopping mall management system comprising:
a cyber shopping mall management apparatus for providing information about at least one wear item for sale;
a display unit for receiving the information about the at least one wear item through a communication network and displaying the at least one wear item; and
a buyer terminal for transmitting to the cyber shopping mall management apparatus a selection signal for selecting a wear item from among the displayed at least one wear item, an image of an object to wear the selected wear item, and an actual size of a specific portion of the object,
wherein the cyber shopping mall management apparatus comprises:
a transmitter for transmitting the information about the at least one wear item to the display unit so that the at least one wear item can be displayed;
a receiver for receiving from the buyer terminal a selection signal for selecting the wear item, the image of the object to wear the selected wear item, and the actual size of the specific portion of the object;
a calculator for computing an image size of the specific portion of the object and for computing an object image ratio between the computed image size and the actual size;
an adjuster for adjusting an image of the selected wear item according to the computed object image ratio; and
a synthesizer for synthesizing the adjusted image of the selected wear item onto a portion of the object image to display wearing of the wear item,
wherein the transmitter transmits the image synthesized by the synthesizer to the buyer terminal.

16. The system of claim 15, wherein the display unit includes at least one of a display of the buyer terminal, a television, and a personal computer monitor.

17. The system of claim 15, wherein the calculator extracts the specific portion from the received object image and computes the image size of the specific portion.

18. The system of claim 17, wherein the computed image size and the corresponding actual size are one of a length and an area of the specific portion.

19. The system of claim 18, wherein the adjuster adjusts a ratio between the image size of the selected wear item and an actual size of the selected wear item to be equal to the computed object image ratio.

20. The system of claim 18, wherein the adjuster adjusts the computed object image ratio of the received object image to be equal to a ratio between the image size of the selected wear item and the actual size of the selected wear item.

21. The system of claim 15, wherein the receiver receives information necessary to purchase the selected wear item from the buyer terminal.
